(19) United States
(12) Patent Application Publication
(10) Pub. No.: US 2008/0150246 A1
(43) Pub. Date: Jun. 26, 2008

(54) Trash Receptacle Utility Cart

(76) Inventors: John E. Lox, Cottage Hills, IL (US); Freddie A. Childers, South Roxana, IL (US)

Correspondence Address: HARSHAW RESEARCH, INC., 210 W. TECUMSEH STREET, OTTAWA, KS, 66067, US

(21) Appl. No.: 12/047,118

(22) Filed: Mar. 12, 2008

Related U.S. Application Data
(63) Continuation-in-part of application No. 11/321,805, filed on Dec. 29, 2005.

(51) Int. Cl. B62B 3/10

(52) U.S. Cl. 280/47.34

(57) ABSTRACT

A utility cart includes a framework having a floor with a plurality of floor support members, the floor having a generally planar and rectangular configuration and defining four corners. The framework includes a pair of rear corner posts and a pair of front corner posts, each rear and front corner post extending upwardly from a respective corner. At least two lower side retaining members and two upper side retaining members extend between respective front and rear corner posts. A pair of retaining arms is pivotally coupled to a front corner post, retaining arm being selectively receivable in respective retaining clips mounted to another front retaining post. The utility cart includes a pair of wheels for movement thereof, a ramp for loading trash containers onto the floor, a ground anchor, a lid locking assembly, and reflectors.

### REFERENCE TO RELATED APPLICATIONS

The present application is a Continuation-In-Part of application Ser. No. 11/321,805 filed Dec. 29, 2005, entitled Trash Receptacle Utility Cart.

### BACKGROUND OF THE INVENTION

The present invention relates to carts, and more specifically but not by way of limitation to a utility cart that is designed to receive a plurality of standard trash receptacles and configures to facilitate the movement and storage of the trash receptacles. The cart is further configured to engage with a variety of anchors to secure the cart to prevent the cart from tipping and to prevent the theft of the cart.

Individuals commonly use standard trash receptacles around their homes to collect different types of refuse. Household trash is collected in these conventional containers which are usually made of a lightweight material such as aluminum or plastic. The trash receptacles are light weight so that once the receptacle is loaded with refuse, it can be easily managed by the owner in order to transport the load trash receptacle to the street for collection by a municipal waste management company.

The light weight of the standard trash receptacle creates several problems. The trash receptacles are prone to be knocked over during any substantial storm or on a windy day thereby releasing some or all of the trash contained therein. This creates an undesirable and unsanitary situation as the owner must collect the trash that has been strewn over the street and yard.

Another issue involves animals. Whether domestic or wild, the lightweight receptacles are easily tipped over and rummaged through by a neighborhood dog or other animal. This again results in an undesirable situation where the trash within the trash receptacle has become strewn across the yard and street whereby the owner must re-collect the trash and place in the receptacle.

Another issue with standard trash receptacles involves the transportation thereof. Typically, a homeowner will have at least two trash receptacles that must be transported to the street for collection. Moving two or more loaded trash receptacles can be a cumbersome challenge.

Accordingly there is a need for a device that facilitates the storage of a plurality of standard trash receptacle which secures the trash receptacles and maintains the trash receptacles in an upright position under all adverse weather conditions. The device should further be equipped to aid in the transportation of the plurality of trash receptacles.

### SUMMARY OF THE INVENTION

Accordingly, a utility cart according to a preferred embodiment of the present invention includes a framework having a floor with a plurality of floor support members, the floor having a generally planar and rectangular configuration and defining four corners. The framework includes a pair of rear corner posts and a pair of front corner posts, each rear and front corner post extending upwardly from a respective corner. At least two lower side retaining members and two upper side retaining members extend between respective front and rear corner posts. A pair of retaining arms is pivotally coupled to a front corner post, retaining arm being selectively receivable in respective retaining clips mounted to another front retaining post. The utility cart includes a pair of wheels for movement thereof, a ramp for loading trash containers onto the floor, a ground anchor, a lid locking assembly, and reflectors.

Therefore, a general object of this invention is to provide a utility cart that releasably secures a plurality of trash receptacles and maintains them in an upright position during adverse weather conditions.

Another object of this invention is to provide a utility cart, as aforesaid, that facilitates the transportation of a plurality of standard trash receptacles.

A further object of this invention is to provide a utility cart, as aforesaid, that secures a plurality of trash receptacles in an upright position and facilitates the transportation thereof and further includes a retaining mechanism that secures the device to a suitable horizontal support structure.

A still further object of this invention is to provide a utility cart, as aforesaid, that secures a plurality of trash receptacles in an upright position and facilitates the movement thereof that is lightweight and easy to use.

Another object of this invention is to provide a utility cart, as aforesaid, that secures a plurality of trash receptacles in an upright position and facilitates the movement thereof that can be releasably secured to a standard yard tractor.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

FIG. 1 is a perspective view of a trash receptacle utility cart according a preferred embodiment of the present invention with a handle in an extended configuration and a trailer hitch in a retracted configuration;

FIG. 2 is a perspective view of the utility cart as in FIG. 1 with the handle in a retracted configuration and the trailer hitch in an extended configuration;

FIG. 3a is another perspective view of the utility cart as in FIG. 1 in use with a ground anchor;

FIG. 3b is an isolated view on an enlarged scale taken from a portion of FIG. 3a;

FIG. 3c is another isolated view on an enlarged scale taken from a portion of FIG. 3a showing an another type of ground anchor;

FIG. 4 is a perspective view of the utility cart as in FIG. 2 taken from a reverse angle and showing a ramp in a retracted or storage configuration and retaining arm in a closed configuration;

FIG. 5 is a perspective view of the utility cart, as in FIG. 4 with the ramp in a deployed configuration and with the retaining arm in an open configuration;

FIG. 6 is a perspective view on an enlarged scale of a ground anchor as in FIG. 3c;

FIG. 7 is a perspective view of the utility cart as in FIG. 2 having a storage bin attached; and

FIG. 8 is a perspective view of the utility cart as in FIG. 2 in use with a trash receptacle and having a lid locking assembly.

### DESCRIPTION OF THE PREFERRED EMBODIMENT

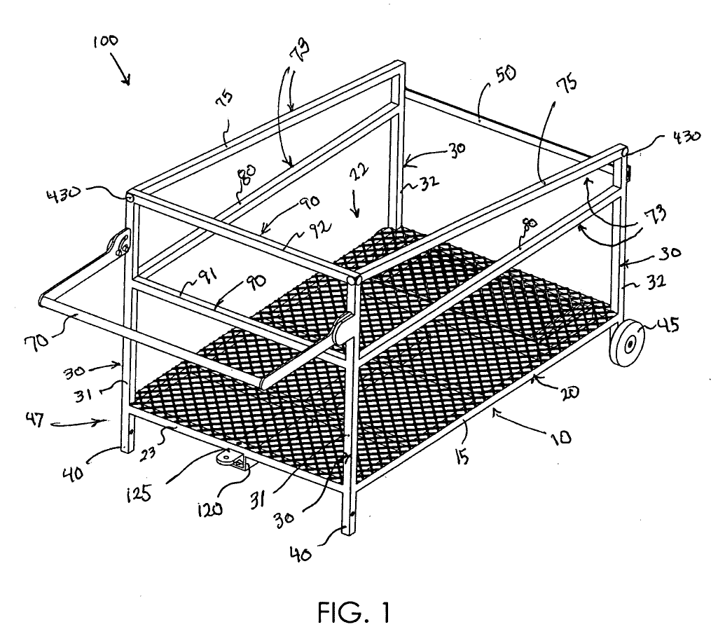

A utility cart according to a preferred embodiment of the present invention will now be described in detail with reference to FIGS. 1 to 8 of the accompanying drawings.

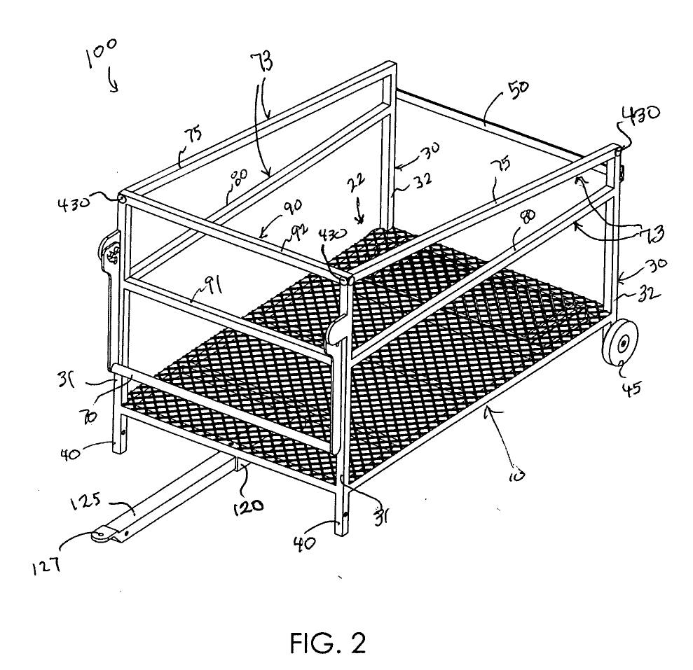

As shown in FIGS. 1 and 2, a utility cart 100 includes a framework having a floor 10 configured in a substantially planar manner and generally rectangular in shape. The floor 10 is constructed of a suitable rigid material such as but not limited to wire mesh so as to prevent the collection of debris and liquid. Although no particular size of wire mesh is required, good results have been achieved with a sheet of one inch wire mesh. Circumferentially disposed around the peripheral edge 15 of the floor 10 are floor support members 20. The floor support members 20 are manufactured from square tubing such as but not limited to aluminum tubing. The floor support members 20 function to provide structural support for the floor 10. In other words, the floor is situated atop the floor support members. There are two side floor support members 21 mounted on opposing sides of the floor. 10 and two end floor support members 23 mounted on opposing ends of the floor 10 connecting the ends of the side floor support members 21. The floor support members 20 are mechanically fastened to the floor 10 by conventional methods such as but not limited to welding.

The floor support members 20 and the floor 10 function to define the platform area 22 on which objects may be placed to be releasably secured or transported by the utility cart 100. Although no specific measurement is required, good results have been achieved with side floor support members 21 that are approximately forty-eight inches in length. Furthermore, good results have also been achieved with end floor support members 23 that are approximately 28 inches in length. Those skilled in the art will recognize that numerous different shapes of tubing could be used in place of and/or in conjunction with the tubing referenced herein to construct the floor support members 20 and achieve the desired functionality. It should be further recognized that the platform area 22 could be manufactured in numerous different shapes and achieve the desired functionality.

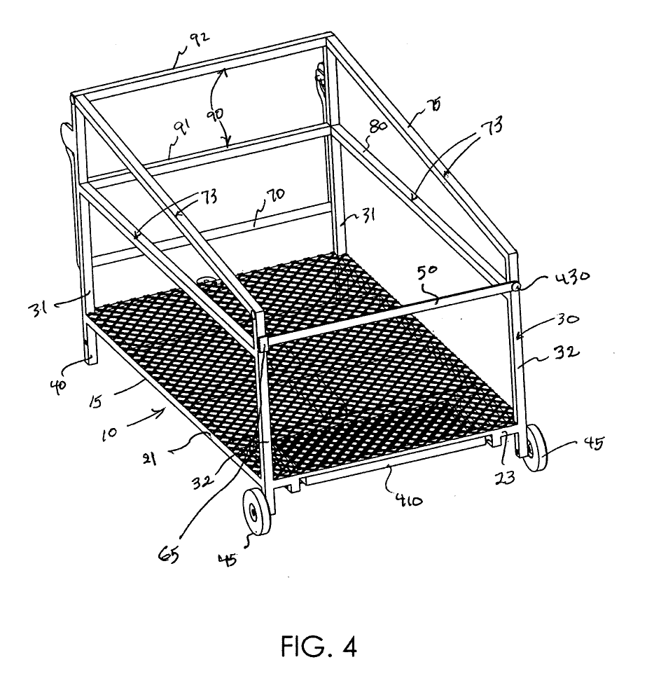

The framework further includes a plurality of corner posts 30. More particularly, a pair of rear corner posts 31 and a pair of front corner posts 32 are attached to and extend upwardly from respective floor supporting members 20 (FIGS. 1 and 4). They are positioned to generally extend upwardly through each corner of the platform area of the floor.

The corner posts 30 are manufactured from square tubing such as but not limited to aluminum. Although no specific length is required, good results have been achieved with corner posts 30 that are approximately thirty eight inches in length for the rear corner posts 31 and thirty two inches for the two front corner posts 32. The corner posts 30 are mechanically secured proximate their first end to the corners of the platform area 22 by conventional mechanical methods such as but not limited to welding.

Connecting the corner posts 30 are four side retaining members 73 (FIG. 1). Two lower side retaining members 80 are mounted intermediate the front corner post 32 and the rear corner post 31 on opposing sides of the platform area 22 and are configured in a horizontal manner. The lower side retaining members 80 are manufactured from square metal tubing or other suitable durable rigid materials and are conventional secured by mechanical methods such as bolts or welding. Although no specific attachment point is required, good results have been achieved whereby the lower side retaining member 80 is secured five and three/quarters of an inch below the second end of the front corner posts 32 and nine and a half inches below the second end of the rear corner posts 31.

Distally secured to the second ends of the front corner posts 32 and the rear corner posts 31 on opposing sides are two upper side retaining members 75. The upper side retaining members 75 are manufactured from a durable rigid material such as but not limited to square metal tubing. The upper side retaining members 75 are secured to the second ends of the corner posts 30 with conventional mechanical methods such as welding. The upper side retaining members 75 are configured in an angular manner sloping downward from the rear corner posts 31 towards the front corner posts 32.

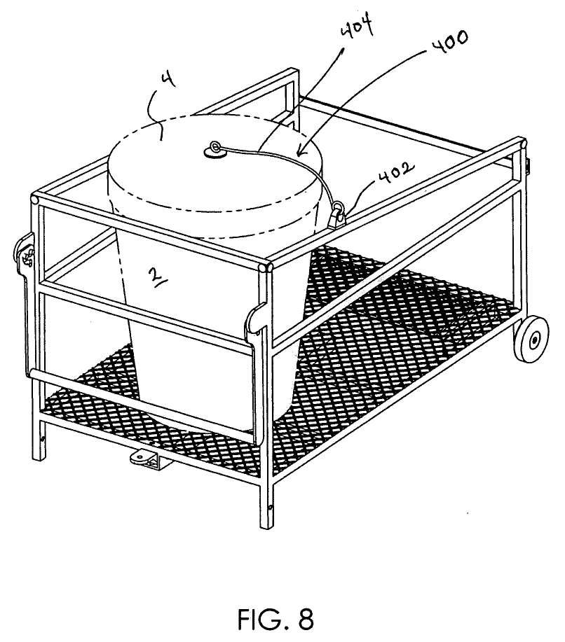

At least one of the upper side retaining members 75 includes a lid-locking assembly 400 (FIG. 8). The lid-locking assembly 400 includes a mounting member 402 attached to the upper side retaining member 75 and includes a cord or chain 404 coupled thereto. The chain 404 may include a coupling for attachment to the lid 4 of a trash receptacle 2 that may be situated upon the floor (FIG. 8). Thus, the lid 4 of a trash receptacle will not become lost or separated from the cart, such as by the wind or an animal that may rummage through the trash receptacle 2.

Integrally mounted with the rear corner posts 31 and contiguous therewith are the rear legs 40. The rear legs 40 are mounted beneath the floor 10 and function to support the utility cart 100 above the ground. The rear legs 40 are manufactured from a suitable durable material such as metal tubing and are mechanically fastened to the first end of the rear corner posts 31 by conventional methods such as welding. It is also contemplated within the scope of the present invention that the rear corner posts 31 are mounted such that a portion thereof extends beneath the floor thereby creating a leg portion that would function to support the rear end 47 of the cart above the ground.

Mounted intermediate the two rear corner posts 31 and configured in a horizontal manner are two rear retaining members 90 (FIG. 1). A lower rear retaining member 91 is mounted above the platform area 22 and secured approximately parallel with the lower side retaining members 80. The lower rear retaining member 91 is manufactured from square metal tubing or other suitable durable rigid material. Interposed to the second end of the rear corner posts 31 and perpendicular thereto is an upper rear retaining member 92. The upper rear retaining member 92 is secured by conventional mechanical methods such as but not limited to welding.

Hingedly mounted to the rear corner posts 31 distal to the floor and generally above the lower rear retaining member 91 is a handle 70 (FIG. 1). The handle 70 is manufactured from a durable rigid material such as metal or plastic. The handle 70 is a square u-shaped bar with opposing ends that are conventionally secured to the rear corner posts 31 with a standard hinge mechanism. The handle 70 is movable between first configuration generally parallel to the rear corner posts 31 (FIG. 2) and a second configuration generally perpendicular to the rear corner posts 31 (FIG. 1). In its second position, the user can leverage the handle 70 to lift the utility cart in an upwards direction thereby preparing the utility cart for transportation by disengaging the rear legs 40 with the ground. Although no specific length is required, good results have been achieved with a handle 70 that is approximately sixteen inches in length. Although the handle is illustrated in the drawings submitted herewith as being generally a square u-shaped handle, it is further contemplated within the scope of the present invention that the handle 70 could be a single bar that is mounted to one of the two rear corner posts 31. Furthermore, the handle 70 could have disposed substantially thereon a durable foam material to facilitate a more comfortable grip for the user of the utility cart 100. Those skilled in the art will recognize that numerous different shapes of tubing could be used to manufacture the handle and perform the desired function as described herein.

Pivotally mounted on one of the front corner posts 32 is a retaining arm 50. The retaining arm 50 includes a first end that is pivotally mounted on the same front corner post 50. As shown in particular in FIG. 4, mounted on the opposing front corner post 32 is a retaining arm clip 65. The retaining arm clip 65 is a bracket that is designed to receive and support therein the second end of the retaining arm 50. The retaining arm clip 65 is secured to the front corner post 32 by conventional mechanical methods such as but not limited to welding. The user will pivot the retaining arm 50 out of its first position whereby the retaining arm 50 will be oriented in a perpendicular manner with respect to the front corner posts 32 and secure the second end of the retaining arm 50 into the retaining arm clip 65. Although the utility cart 100 is illustrated as having one retaining arm 50, those skilled in the art should recognize that numerous different amounts of retaining arms 50 could be used to achieve the desired function described herein.

Mounted adjacent to the front corner posts 32 proximate to the platform area 22 is a pair of wheels 45. The wheels 45 are secured by conventional mechanical methods such as but not limited to bolts. The wheels 45 function to facilitate the transportation of the utility cart 100 when the handle 70 is leveraged in an upwards direction thereby disengaging the rear legs 40 from the ground. This position allows the user to roll the utility cart to the desired destination.

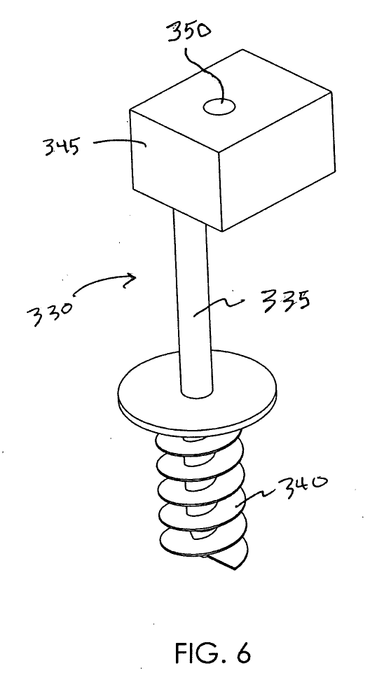

Now referring in particular to FIGS. 1 and 2, secured beneath one of the end floor support members is a hitch receiver 120. The hitch receiver 120 is three sided bracket welded or secured by other suitable methods that is configured to receive therein a hitch shank 125. Preferably, the hitch shank 125 is a square metal tube of sufficient size to be inserted into the hitch receiver 120. It is understood that the shank 125 is movable between first (FIG. 1) and second (FIG. 2) configurations. On one end of the hitch shank 125 an aperture 127 is present such that the shank 125 may be coupled to a complementary coupling on a lawn tractor or the like. Although no specific length is required, good results have been achieved with a locking pin 130 that is three inches in length. It is also contemplated within the scope of the present invention that the locking pin 130 has a structure located on one end being configured to receive a standard padlock therein (FIG. 6). Opposite the aperture 127 the hitch shank 125 has fastened thereto a mounting plate 135 that is used to interface with utility vehicles such as but not limited to a yard tractor.

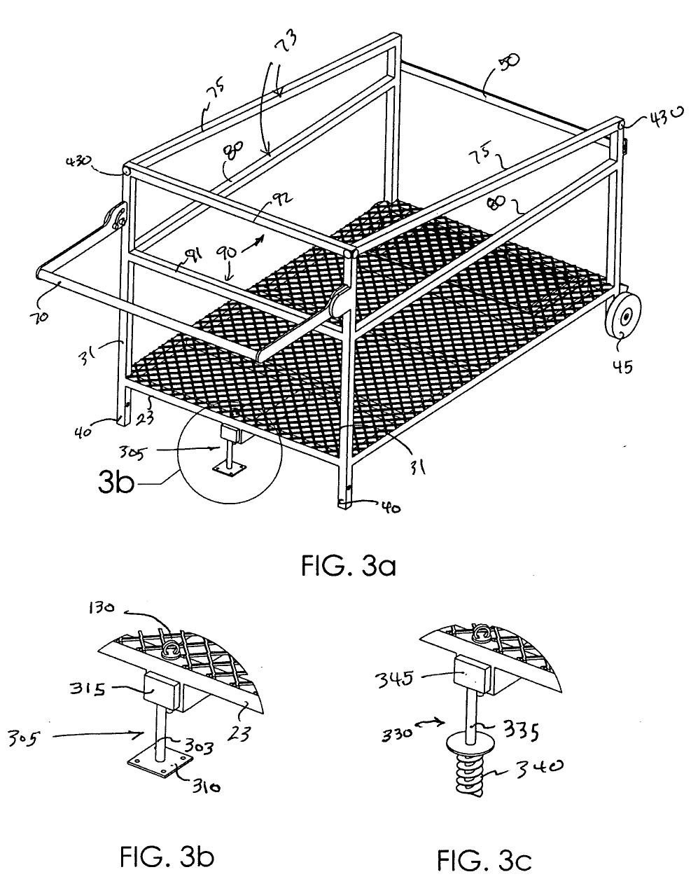

Now referring in particular to FIGS. 3a-3c and 6, there are illustrated anchors 300 that are designed to removably secure the utility cart 100 when it is stored. The concrete anchor 305 is a conventional mechanical anchor with a rod 303 that has mounted to one end a mounting plate 310 whereby the concrete anchor 305 can be mechanically fastened to a concrete surface. Distally located on the rod 303 from the mounting plate 310 is a mounting block 315. The mounting block 315 is of sufficient size to be inserted into the hitch receiver 120. The mounting block 315 has a bore located therein to receive the locking pin to facilitate secure storage of the utility cart. The locking pin 130 may include a configuration capable of receiving a padlock (not shown) and thus locking the ground anchor to the cart.

Still referring to FIGS. 3a through 3c, a dirt anchor 330 is used to releasably secure the utility cart 100 to the ground. The dirt anchor 330 is a standard mechanical anchor that has a rod 335 with an auger bit 340 secured to one end of the rod 335. The auger bit 340 is facilitates the penetration of the dirt anchor 330 into the ground. Secured opposite the auger bit 340 superposed on the rod 335 by suitable methods such as welding is a mounting block 345. The mounting block 345 is of sufficient size to be inserted into the hitch receiver 120 of the utility cart. The mounting block 340 has a hole 350 disposed therein that is of sufficient size to accommodate the locking pin 130.

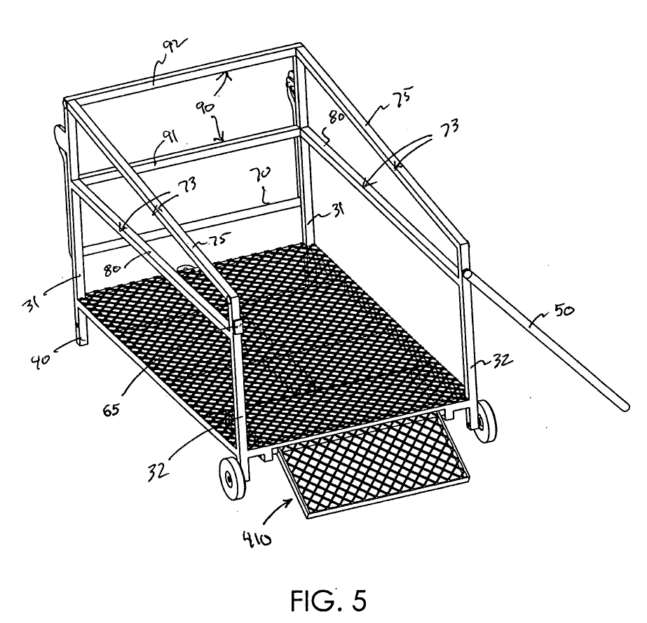

As best shown in FIGS. 4 and 5, the utility cart may include a ramp 410 slidably mounted to respective structures of the cart framework, such as to the end floor support member 23 situated between the front corner posts 32. The ramp 410 is slidably movable between a generally planar retracted configuration (FIG. 4) and a deployed configuration (FIG. 5). When the ramp 410 is extended, it is allowed to pivot downward to the fully deployed configuration so that a trash receptacle 2 may be slidably loaded onto the cart floor.

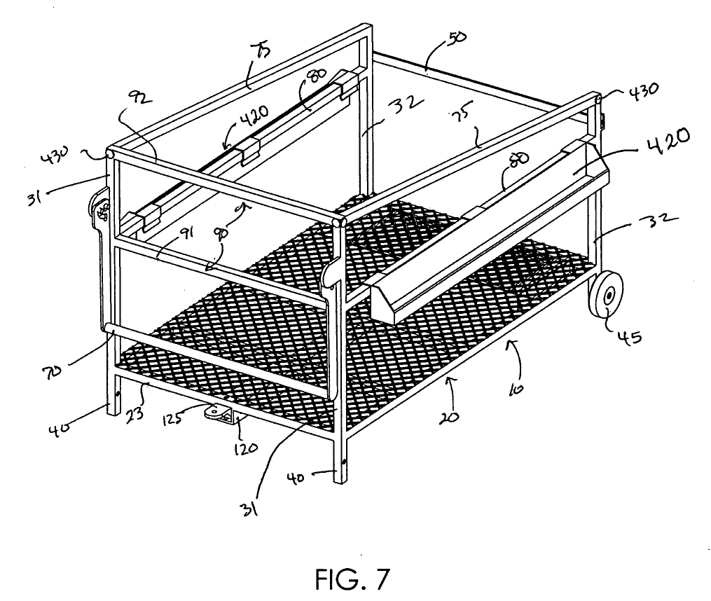

Further, the utility cart 100 may include a storage bin 420 mounted to a side retaining member 73 (FIG. 7). Preferably, the storage bin 420 is coupled to an upper side retaining member 75 with a bracket using traditional hardware or construction techniques such as welding. The utility cart, of course, may include a pair of oppositely disposed and outwardly situated storage bins 420 rather than just one.

The utility cart 100 may include a plurality of reflectors 430 strategically positioned upon the framework so as to reflect the lights of vehicles and thereby be more visible to traffic if situated on or adjacent to a roadway (FIG. 1).

Now referring in particular to FIG. 1, a description of the operation of the utility cart 100 is as follows. The retaining arm 50 may be placed in a first position whereby the retaining arm 50 is parallel with the front corner posts 32. The user may place the desired objects such as but not limited to trash receptacles on the floor 10 of the utility cart 100. If the trash receptacle 2 is heavy or awkward, the ramp 410 may be deployed so that the trash receptacle 2 may be slid up onto the floor of the cart. The user may then secure the trash receptacles in place by placing the retaining arm 50 into its second position whereby the second end of the retaining arm 50 may be secured into the retaining arm clip 65. The lid locking assembly 400 may also be engaged so as to retain a lid 4 of a trash receptacle 2. The user may then proceed to place the dirt anchor 330 into the ground adjacent to the area where the utility cart 100 will be stored. The utility cart 100 may be positioned wherein the mounting block 345 of the dirt anchor 330 is inserted into the hitch receiver 120. The locking pin 130 may be inserted to ensure the utility cart is secured into position. The user may then proceed to fill the trash receptacles 2 with refuse.

If the user desires to move the utility cart 100 by hand to another location such as the street for trash pick-up, the user may remove the locking pin 130 from the mounting block 345 and hitch receiver 120 and lift the handle 70 into its second position. The user may then leverage against the handle 70 in an upwards direction, thereby releasing the legs 40 from the ground. The user may now roll the utility cart 100 on its wheels 45 to the desired location. The user or trash collection workers may open the retaining arm 50 as described above and remove a trash receptacle 2 and dump its contents in a customary fashion. The ramp 410 may be deployed for ease of removing a heavy receptacle 2, if desired.

It is understood that while certain forms of this invention have been illustrated and described, it is not limited thereto except insofar as such limitations are included in the following claims and allowable functional equivalents thereof.

What is claimed is:

1. A utility cart configured to retain and selectively transport at least one trash container, comprising:
a framework including:
a plurality of floor support members;
a floor situated on said floor support member and having a generally planar rectangular configuration and defining four corners, said floor being constructed of wire mesh;
a pair of rear corner posts and a pair of front corner posts, each rear and front corner post extending upwardly from a respective corner;
at least two lower side retaining members and two upper side retaining members extending between respective rear and front corner posts, said upper side retaining members sloping downwardly between respective rear and front retaining posts;
a pair of rear retaining members extending between said rear corner posts;
a retaining arm pivotally mounted to a respective front corner post;
wherein said floor and said plurality of floor support members define a platform area on which to retain the at least one storage container;
a pair of wheels, a respective wheel being attached to a floor support member on opposing sides of said floor downwardly adjacent said front corner posts for aiding the transport of at least one trash container, said cart including only said pair of wheels;
a lid locking assembly coupled to one of said upper side retaining members for holding a lid associated with said trash container;
a handle mounted to said rear corner posts and pivotally movable between a first configuration generally parallel to said rear corner posts and a second configuration generally perpendicular to said rear corner posts.

2. The utility cart as in claim 1, further comprising a ramp slidably coupled to a bottom side of said floor and movable between retracted and extended positions, said ramp also being pivotally movable between a horizontal configuration when at said retracted position and a generally angled configuration when at said extended position.

3. The utility cart as in claim 1, further comprising a reflector attached to each rear corner post.

4. The utility cart as in claim 1, further comprising a hitch receiver slidably mounted to a respective floor support member underneath said floor and movable between retracted and extended configurations, said hitch receiver configured to receive a hitch shank therein.

5. The utility cart as in claim 4, further comprising a ground anchor having opposed first and second ends connected together by a rod, said first end having an auger bit for selectively penetrating a ground surface and said second end having a mounting block being configured so as to be receivable in said hitch receiver.

6. The utility cart as in claim 4, further comprising a ground anchor having opposed first and second ends connected by a rod, said first end having a mounting plate selectively securable to a hard surface with fasteners and said second end having a mounting block being configured so as to be receivable in said hitch receiver.

7. The utility cart as in claim 6 wherein said mounting block defines an opening for receiving a lock.

8. The utility cart as in claim 5 wherein said mounting block defines an opening for receiving a lock.

9. The utility cart as in claim 1, further comprising a retaining clip mounted to said front corner post opposite said retaining arm, said retaining clip being configured to selectively receive a free end of said retaining arm.

10. The utility cart as in claim 1, further comprising a storage bin coupled to a respective upper side retaining member, said storage bin being configured to receive and secure articles.

11. A utility cart configured to retain and selectively transport at least one trash container, comprising:
a framework including:
a plurality of floor support members;
a floor situated on said floor support member and having a generally planar rectangular configuration and defining four corners, said floor being constructed of wire mesh;
a pair of rear corner posts and a pair of front corner posts, each rear and front corner post extending upwardly from a respective corner;
at least two lower side retaining members and two upper side retaining members extending between respective rear and front corner posts;
a pair of rear retaining members extending between said rear corner posts;
an arm pivotally mounted to a respective front corner post;
a retaining clip mounted to a front corner post opposed to said respective front corner post to which said retaining arm is attached, said retaining clip having a configuration for selectively receiving a free end of said retaining arm;
a pair of wheels, a respective wheel being attached to a floor support member on opposing sides of said floor downwardly adjacent said front corner posts for aiding the transport of at least one trash container, said cart including only said pair of wheels;
a ramp slidably coupled to a bottom side of said floor and movable between retracted and extended positions, said ramp also being pivotally movable between a horizontal configuration when at said retracted position and a generally angled configuration when at said extended position.

12. The utility cart as in claim 11, further comprising:
a lid locking assembly coupled to one of said upper side retaining members for holding a lid associated with said trash container;
a handle mounted to said rear corner posts and pivotally movable between a first configuration generally parallel to said rear corner posts and a second configuration generally perpendicular to said rear corner posts.

13. The utility cart as in claim 12, further comprising a reflector attached to each rear corner post.

14. The utility cart as in claim 12, further comprising a hitch receiver slidably mounted to a respective floor support member underneath said platform and movable between retracted and extended configurations, said hitch receiver configured to receive a hitch shank therein.

15. The utility cart as in claim 14, further comprising a ground anchor having opposed first and second ends connected together by a rod, said first end having an auger bit for selectively penetrating a ground surface and said second end having a mounting block being configured so as to be receivable in said hitch receiver.

16. The utility cart as in claim 14, further comprising a ground anchor having opposed first and second ends connected by a rod, said first end having a mounting plate selectively securable to a hard surface with fasteners and said second end having a mounting block being configured so as to be receivable in said hitch receiver.

17. The utility cart as in claim 16, wherein said mounting block defines an opening for receiving a lock.

18. The utility cart as in claim 15, wherein said mounting block defines an opening for receiving a lock.

19. The utility cart as in claim 11, further comprising a storage bin coupled to a respective upper side retaining member, said storage bin being configured to receive and secure articles.

20. The utility cart as in claim 11, wherein said upper side retaining members slope downwardly between respective rear and front retaining posts.
